(19) United States
(12) Patent Application Publication
(10) Pub. No.: US 2008/0148923 A1
(43) Pub. Date: Jun. 26, 2008

(54) MUSIC PLAYER AND A METHOD OF PLAYING MUSIC THEREIN

(76) Inventor: Kyung Yoon Choo, Daejeon (KR)

Correspondence Address: BIRCH STEWART KOLASCH & BIRCH, PO BOX 747, FALLS CHURCH, VA, 22040-0747, US

(21) Appl. No.: 11/759,815

(22) Filed: Jun. 7, 2007

(30) Foreign Application Priority Data
Dec. 21, 2006 (KR) 10-2006-0132091

(51) Int. Cl. G10H 7/00

(52) U.S. Cl. 84/609

(57) ABSTRACT

The present invention is directed to a method of playing music in a music player comprising:

(a) arranging a plurality of music files saved in a memory in a first order; (b) playing the music files according to the order; (c) inputting a conversion signal while the music files are played in the order; and (d) playing the music files in a second order opposite to the first order according to a conversion signal. Also, the present invention is directed to a music player comprising: a music playing unit of recognizing and playing a plurality of music files; and a selection unit of inputting a conversion signal to play the music files forward or backward.

### CROSS-REFERENCE TO A RELATED APPLICATION

The present application claims the benefit of priority under 35 U.S.C. 119 based on the Korean Patent Application No. 10-2006-0132091 filed on Dec. 21, 2006. This application in its entirety is incorporated herein by reference.

### BACKGROUND

1. Field

The present invention relates to a music player, and a method of playing music therein.

2. Background

MP3 player universally used as a music player plays a digitalized audio signal downloaded from the internet using a computer communication. MP3 player downloads MP3 format files from a computer having communication means, saves the MP3 format files in a flash memory, and plays the files as audio signal having high sound quality for hours. MP3 player is easy to carry, and so has been widely used.

MP3 format files saved in MP3 player are arranged according to a certain criterion, for example, according to file names.

In case a user inputs a playing signal to MP3 player, MP3 player plays MP3 format files in order, according to a predetermined list of MP3 format files.

However, if a user wants to listen to MP3 format files saved in MP3 player in another order, he should have designated the files he want to listen to, one by one among the MP3 format files saved in memory.

Therefore, a MP3 player which can simply select MP3 format files has been in need.

### BRIEF DESCRIPTION OF THE DRAWINGS

Preferable embodiments will be described in detail with reference to the following drawings in which same reference numerals refer to same elements wherein:

FIG. 1 is a block diagram illustrating the music player according to one embodiment of the present invention;

FIG. 2 is a flow chart illustrating the playing method of MP3 player according to one embodiment of the present invention;

FIGS. 3a to 3d are views illustrating playing the MP3 files in a first order;

FIGS. 4a to 4e are views illustrating playing the MP3 files in a second order according to an input of conversion signal; and

FIGS. 5a to 5e are views illustrating playing the MP3 files in a first order according to a re-input of conversion signal.

### DETAILED DESCRIPTION OF THE INVENTION

The object of the present invention is to provide a music player that can play music files saved inside backward as well as forward, and can be used very conveniently by user, and a method of playing music therein.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

In the following drawings, same reference numbers will be used to refer to same or similar parts through all embodiments. Thus, the descriptions for identical parts are not repeated.

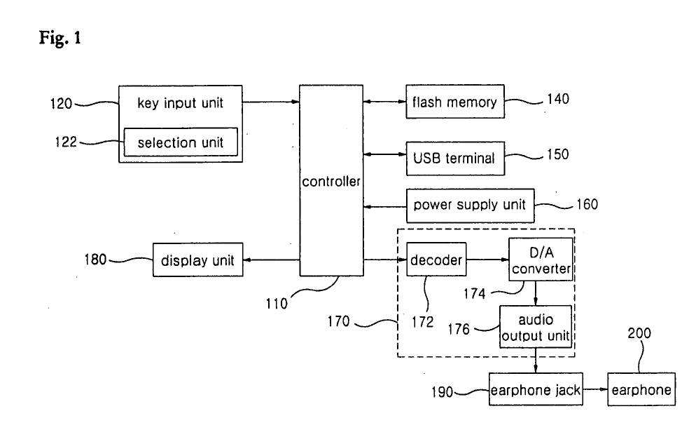

FIG. 1 is a block diagram illustrating the music player according to one embodiment of the present invention.

Referring to FIG. 1, the music player of the present invention comprises controller 110, music playing unit 170, key input unit 120, flash memory 140, terminal 150, power supply unit 160, display unit 180, and earphone 200.

The music player of the present invention may be MP3 player, device for MIDI, window media player, WINAMP, etc.

Depending on the kind of music player applied to the present invention, the kind of music files played in each player may be changed.

For example, MP3 format file, MID format file, RMI format file, WRK format file, WAV format file, or MOD format file may be used as the music file.

MP3 format file is a file to compress audio data by using MPEG which is a movie file compression technique, and can play music as good as CD, with small capacity.

MID format file and RMI format file arc music data files for MIDI, and have a separated sound source in a device for MIDI. MID format file and RMI format file have only such music information as length, high and low, etc., like a score. Thus, a device for MIDI is needed to play the above files.

WAV format file is a sound file by Microsoft Corporation. It is basically used as playing and recording sound. WAV format file is digital file converted from analog sound, and is saved as is without compressing. Thus, the file takes large space.

MOD format file is a file to play music, like the file for MIDI. It can play an authentic version from general sound card since it has a sound source inside. However, it takes large space due to the sound source.

Controller 110 controls writing/reading data of flash memory 140.

The controller 110 recognizes an address included in a packet outputted from a terminal 150, and records data included in the packet into a flash memory 140, or transmits the data outputted from the flash memory 140 to the terminal 150.

Also, the controller 110 controls key input unit 120, display unit 180, and music playing unit 170, in order to output audio data saved in the flash memory 140 through earphone jack.

Also, the terminal 150 is formed from an edge of the music player. The terminal 150 may be USB type, SD-type, Micro SD-type, CF-type or MMC type.

The terminal 150 may be connected to information terminal apparatus such as computer, may download a music file saved in the information terminal apparatus, and output a packet received from the information terminal apparatus to the controller 110.

When the terminal 150 is connected to the information terminal apparatus, it receives a power from the information terminal apparatus, and charges a power supply unit 160.

The power supply unit 160 provides the music player with a power necessary to operate.

The power supply unit 160 may be, for example, portable power device such as dry battery and recharging battery, adapter connector, etc.

A preferable one is a recharging battery which is charged through the terminal 150 connected to the information terminal device. More preferably Li-Polymer battery can be used.

Flash memory 140 saves a packet received from the terminal 150, and consists of NOR-type memory and NAND-type memory.

The NOR-type memory has a parallel structure and can access a random cell. And, the process to recognize inner address at the time of reading/writing operation is simple. However, the NOR-type memory requires an electrode to access each cell connected in parallel, and so has a disadvantageous that the entire space should be wide.

The NAND-type memory has a series structure, and first moves to a block to read each data of cells connected in series. Therefore, the reacting/writing speed of NAND-type memory is slower than that of the NOR-type memory, but the NAND-type memory takes less space.

For the present music player, it is preferable to use the NAND-type flash memory.

The key input unit 120 comprises various buttons to determine playing of audio data, playing method, display form of the display unit, etc.

Also, the key input unit 120 comprises a selection unit 122 to select a playing mode of the music player.

A playing mode of music files saved in the flash memory 140 is selected from the selection unit 122, and includes a forward playing mode and a backward playing mode.

For example, in case the conversion signal is inputted from the selection unit 122 while music files are played forward, the music files are played backward.

Also, in case the conversion signal is re-inputted from the selection unit 122 while music files are played backward, the music files are played forward.

The button constitution and operation of the selection unit 122 are not limited to the above constitution and method.

The music playing unit 170 comprises decoder 172, D/A converter 174, and audio output unit 176.

The decoder 172 recognizes and decodes audio data information to generate audio digital data.

The D/A converter 174 converts the audio digital data to analog signal, and generates audio analog data.

The audio output unit 176 amplifies the audio analog data received from the D/A converter 174]; formats them into a standard waveform, and outputs them to an earphone jack 190.

Accordingly, a user can listen to the audio data through earphone 200 under optimum condition.

The earphone jack 190 is a connection part to transmit the audio data to the earphone 200, and the earphone 200 is inserted and connected electrically thereto.

The display unit 180 displays, for example, an information of flash memory 140, an information of audio data, an operation condition of the music player, etc. Also, the display unit 180 displays whether the playing mode is forward or backward.

Hereinafter, the method of playing music of the present music player according to one embodiment of the present invention will be described in detail. MP3 player will be exemplified as the music player, but the method can be applied to other music players.

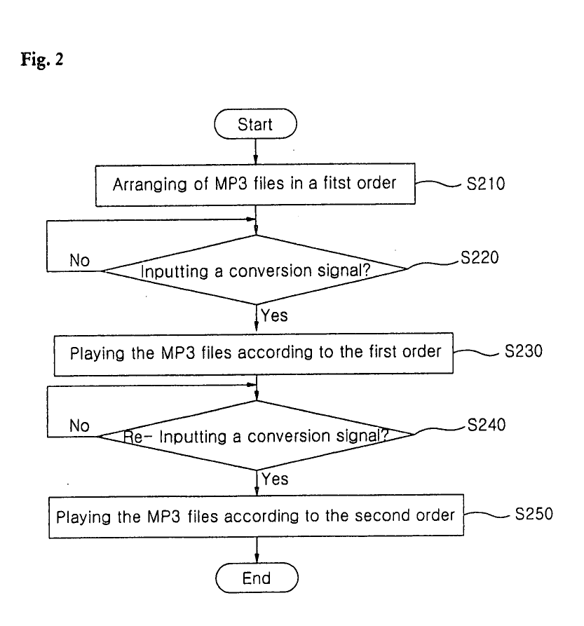

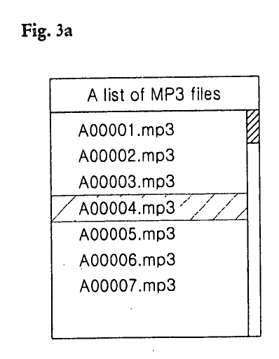

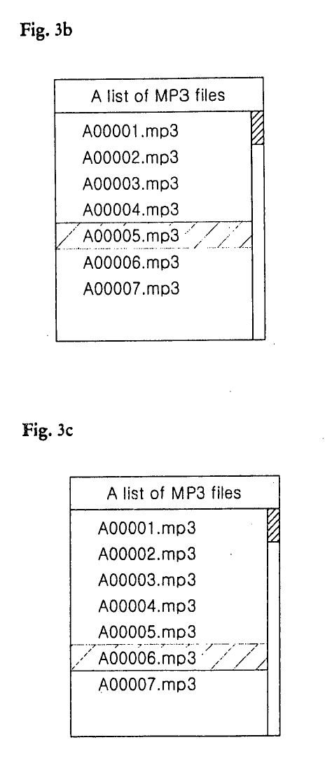

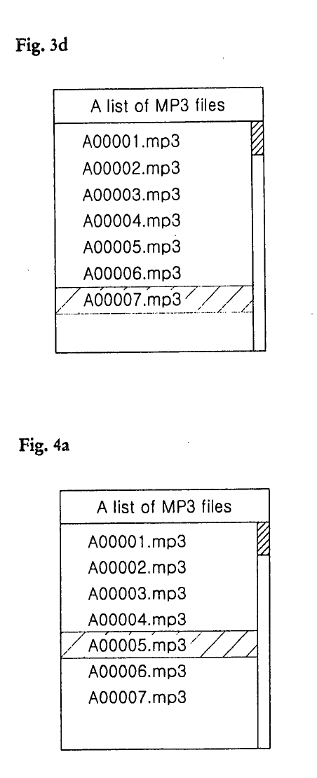

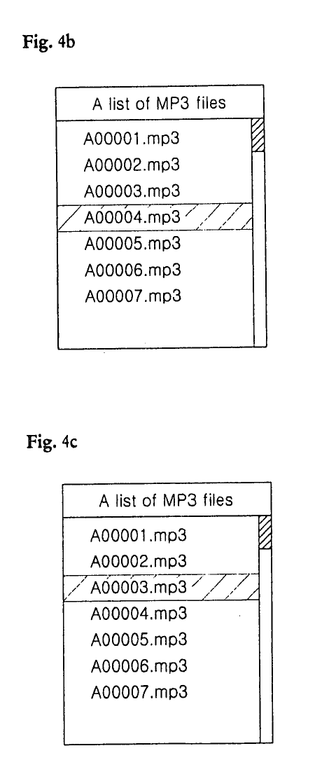

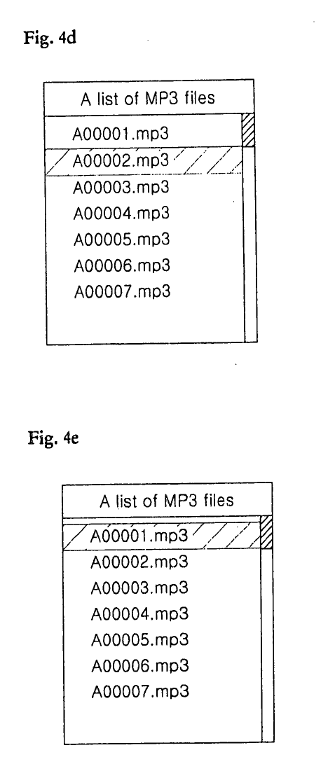

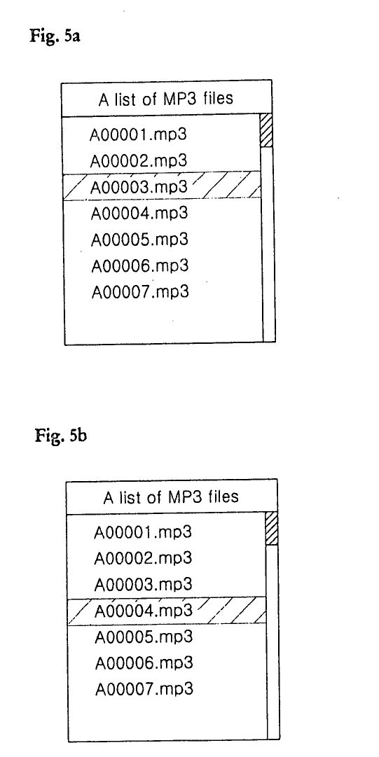

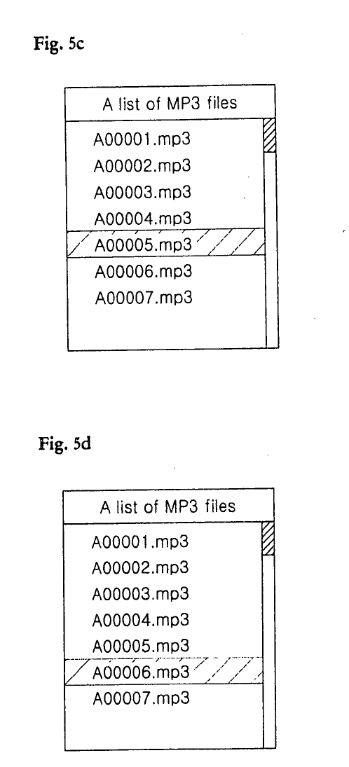

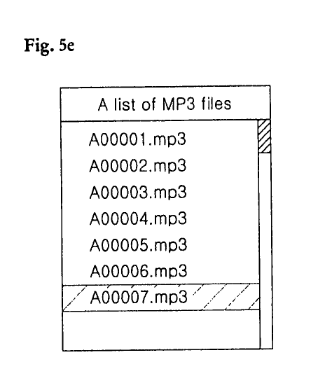

FIG. 2 is a flow chart illustrating the playing method of MP3 player according to one embodiment of the present invention; FIGS. 3a to 3d are views illustrating playing the MP3 files in a first order; FIGS. 4a to 4e are views illustrating playing the MP3 files in a second order according to an input of conversion signal; and FIGS. 5a to 5e are views illustrating playing the MP3 files in a first order according to a re-input of conversion signal.

Referring to FIG. 2, when a user inputs an on-signal to the MP3 player by using a key input unit 120, the controller 110 reads the information of MP3 format files saved in the flash memory 140. The information may be, for example, record capacity, record location, or file name.

Then, the display unit 180 displays the list of MP3 format files arranged, as shown in FIG. 2 (S210).

The order of arranging MP3 format files is not particularly limited, and could be, for example, in file names.

Then, the controller 110 determines whether the playing signal is inputted from the key input unit 120 (S220).

When the playing signal is inputted, the signal is transmitted to the music playing unit 170, and then a selected MP3 format file is played (S230). For example, as shown in FIGS. 3a to 3d, the number of MP3 format files saved in the flash memory 140 is seven (7), and in case the user selects fourth MP3 format file among them, the fourth MP3 format file is played. When the playing of fourth MP3 format file is over, fifth, sixth, and seventh MP3 format files are played next in order unless another control signal is inputted.

In case a user does not designate a certain MP3 format file, MP3 files are played from the beginning of the list of MP3 format files.

While the music playing unit 170 plays MP3 format files, the controller 110 determines whether a conversion signal is inputted from the selection unit 122 (S240).

In case a conversion signal is inputted, the controller 110 transmits a reverse playing signal to the music playing unit 170 (S250).

For example, as shown in FIGS. 4a to 4e, in case a conversion signal is inputted while fifth MP3 format file is played, the music playing unit 170 plays the music files backward, that is, in the order of fifth, fourth, third, second, and first MP3 format file.

And, in case a conversion signal is re-inputted while the music playing unit 170 plays the music files backward, the music playing unit 170 plays the MP3 files forward.

For example, as shown in FIGS. 5a to 5e, in case the conversion signal is re-inputted while third MP3 format file is played, the music playing unit 170 plays the MP3 files forward, that is, in the order of third, fourth, fifth, sixth and seventh MP3 format file.

As described above, according to the selection of user, the music player plays the music files forward or backward.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of playing music in a music player comprising:
(a) arranging a plurality of music files saved in a memory in a first order;
(b) playing the music files according to the first order;
(c) inputting a conversion signal while the music files are played in the order; and
(d) playing the music files in a second order opposite to the first order according to the conversion signal.

2. The method of claim 1, further comprising a step of playing music files according to the first order in case of re-inputting the conversion signal.

3. The method of claim 1, wherein the music file is MP3 format file, MID format file, RMI format file, WRK format file, WAV format file, or MOD format file.

4. A music player comprising:
a music playing unit of recognizing and playing a plurality of music files; and
a selection unit of inputting a conversion signal to play the music files forward or backward.

5. The music player of claim 4, wherein the music playing unit plays the music files forward or backward whenever a conversion signal is inputted from the selection unit.

6. The music player of claim 4, further comprising:
a terminal connected to an information terminal apparatus, and transmitting music files; and
a power supply unit supplying a power charged electrically through the terminal from the information terminal apparatus, to the music player unit.

7. The music player of claim 6, wherein the terminal is USB type, SD-type, Micro SD-type, CF-type or MMC type.

8. The music player of claim 6, wherein the power supply unit is lithium polymer battery.

9. The music player of claim 4, further comprising a display unit displaying the information of music files or conversion signal.

10. The music player of claim 4, wherein the music player is MP3 player, device for MIDI, window media player, or WINAMP.

11. The music player of claim 4, wherein the music file is MP3 format file, MID format file, RMI format file, WRK format file, WAV format file, or MOD format file.
